(19) United States
(12) Patent Application Publication
(10) Pub. No.: US 2012/0278445 A1
(43) Pub. Date: Nov. 1, 2012

(54) LOAD BALANCING SYSTEM

(75) Inventors: Takahiro Sagara, Ebina (JP); Yoshiteru Takeshima, Tokyo (JP); Yasushi Miyata, Yokohama (JP)

(73) Assignee: HITACHI, LTD., Tokyo (JP)

(21) Appl. No.: 13/357,685

(22) Filed: Jan. 25, 2012

(30) Foreign Application Priority Data
Apr. 28, 2011 (JP) 2011-100391

(51) Int. Cl. G06F 15/16

(52) U.S. Cl. 709/219

(57) ABSTRACT

A relay apparatus adds a program location indicating a source of a correction program, to a response from a server requested of to acquire contents by the client, and transmits a response to the client. The program location contains tags identifying a response transmitting server and the relay apparatus as parameters. Upon receiving the response from the server via the relay apparatus, the client transmits a correction program acquisition request containing the parameters to a destination (management server) indicated by the program location. Upon receiving the request, the management server generates a correction program which rewrites a contents link, based on the parameters included in the request and transmits it to the client as a response. The client rewrites a contents link destination on the basis of the acquired correction program.

### INCORPORATION BY REFERENCE

This application claims priority based on a Japanese patent application, No. 2011-100391 filed on Apr. 28, 2011, the entire contents of which are incorporated herein by reference.

### BACKGROUND

The subject matter disclosed herein relates to a load balancing method in a system which delivers contents requested from a client via a network to the request source, and the system.

In servers in Web systems which deliver contents requested from a client via a network in recent years, a communication quantity has increased due to spread of the smart phones and rich contents and it has become difficult to process requests in a single server. Furthermore, it is desired to provide service in a plurality of servers geographically located at distances in order to make it possible to continue service even when a disaster has occurred.

In order to solve these problems, there is a technique of wide area load balancing on a network such as the Internet. Conventionally, the DNS round robin implemented by utilizing a DNS server is known as the technique of wide area load balancing (see, for example, JP-A-2004-260332, paragraph [0013]). In the DNS round robin, a plurality of IP addresses are registered in the DNS server for a host name of the server, and a client determines a destination IP address from among a plurality of IP addresses by the round robin.

In the DNS round robin, however, there are problems such as a problem that the load situation of the server is not considered and a problem that reflection to the load balancing is slow in the case where the client has changed a server configuration in order to cache contents of a DNS response.

As a wide area load balancing technique which solves the problems of the DNS round robin, a method of reducing the load of a desired web server by rewriting link information in an HTML (Hyper Text Markup Language) file returned to a client in a web system is also conceivable (see, for example, JP-A-2009-237835 (paragraph [0009] and FIG. 5).

For example, if a client issues an acquisition request of an HTML file to a Web server A, then the Web server A rewrites link information of contents described in an HTML file returned to the client terminal to another Web server B, and then returns the HTML file to the client. When acquiring new contents via a link of acquired contents, a client transmits a request to the Web server B in order to refer to rewritten link information. Since the Web server rewrites link information contained in contents transmitted to the client as a response in this way, the number of times of coupling to the Web server A is decreased and it becomes possible to decrease the load of the Web server A.

### SUMMARY

In a general data center which provides a Web system, a relay apparatus (such as a reverse proxy) which relays a request from a client to a server is installed between the client and servers as shown in FIG. 2, from the view point of security and operational management. A private IP address is assigned to each server, and the relay apparatus receives a request from the client with a plurality of virtual IP (VIP) addresses, and relays the request to a server.

Even if it is attempted to rewrite link information directed to a server A to link information directed to a server A′ in the scheme in which the link information is rewritten, therefore, a virtual IP address of a relay apparatus which relays a request to the server A′ is not known. Therefore, it is difficult to apply the load balancing using the link information rewriting scheme in a server.

Furthermore, link information rewriting by a server needs an individual function in the server. Therefore, it is difficult to apply the link information rewriting by a server to existing Web systems.

In view of the problem, the present specification discloses a load balancing method and, load balancing system, using link information rewriting in a configuration having a relay apparatus in a stage preceding servers, which can be applied to existing systems.

According to one feature of the disclosed communication system, a system including contents servers which provide contents, a client, and a relay apparatus connected via a network has newly a management server which periodically acquires and stores information of a virtual IP address of the relay apparatus and load information of the servers connected to the relay apparatus by conducting communication with the relay apparatus.

Upon receiving response contents for a request of the client from a contents server, the relay apparatus adds a program (description of processing instructions for a computer) location which indicates a source of a correction program to the response contents, and transmits resultant response contents to the request transmitting client. By the way, the program location contains tags identifying the response transmitting server and the relay apparatus as parameters.

Upon receiving the response contents from the server via the relay apparatus, the client transmits a correction program acquisition request containing the parameters, directed to a destination (management server) which is indicated by a program location added to the response contents.

Upon receiving the correction program acquisition request, the management server generates a correction program which rewrites link information contained in the response contents, on the basis of the parameters contained in the correction program request, information of a virtual IP address of the relay apparatus stored in the management server, and load information of the server, and transmits a response to the client.

The client rewrites link information contained in the response contents on the basis of the acquired correction program.

Even in the case of a system configuration having a relay apparatus in a stage preceding servers, load balancing according to the load situation of the servers can be implemented without adding an individual function to the servers, on the basis of the disclosure.

These and other benefits are described throughout the present specification. A further understanding of the nature and advantages of the invention may be realized by reference to the remaining portions of the specification and the attached drawings.

### BRIEF DESCRIPTION OF DRAWINGS

FIG. 1 shows a configuration example of a communication system according to a first embodiment;

FIG. 2 is an example of a configuration diagram showing a connection form of a client, relay apparatuses, and servers;

FIG. 3 shows an example of a configuration diagram of an information processing apparatus used as a client, a relay apparatus, a server, and a management server;

FIG. 4 shows an example of relay apparatus VIP information and relay apparatus load information stored in a management server;

FIG. 5 shows an example of configuration diagrams of identifier information, server load information, and VIP information stored in a relay apparatus;

FIG. 6 shows an example of a contents request and response contents communicated among a server, a relay apparatus, and a client;

FIG. 7 shows an example of configuration diagrams of a program request and a program response communicated between a client and a management server;

FIG. 8 shows an example of configuration diagrams of a load information request and a load information response communicated between a management server and a relay apparatus;

FIG. 9 shows an example of configuration diagrams of a VIP information request and a VIP information response communicated between a management server and a relay apparatus;

FIG. 10 shows an example of a communication sequence in which a client acquires contents from a server and rewrites link information of the contents in the communication system according to the first embodiment;

FIG. 11 shows an example of a communication sequence in which a management server acquires load information from a relay apparatus;

FIG. 12 shows an example of a communication sequence in which a management server acquires VIP information from a relay apparatus;

FIG. 13 shows an example of a flow chart in which a program location addition function in a relay apparatus adds a program to response contents;

FIG. 14 shows an example of a flow chart in which a program response function in a management server generates a program;

FIG. 15 shows an example of a flow chart in which a client rewrites link information in accordance with a program acquired from a management server;

FIG. 16 shows a configuration example of a communication system according to a second embodiment;

FIG. 17 shows a configuration example of a communication system according to a third embodiment;

FIG. 18 shows a configuration example of a communication system according to a fourth embodiment;

FIG. 19 shows a configuration example of a communication system according to a fifth embodiment;

FIG. 20 shows an example of a flow chart in which a program is generated by a program response function of a management server in the second embodiment; and

FIG. 21 shows an example of contents transmitted to a client by a relay apparatus in the fifth embodiment.

### DETAILED DESCRIPTION OF THE EMBODIMENTS

Hereafter, embodiments will be described with reference to the drawings.

In the ensuing embodiments, the case where the HTTP (Hyper Text Transfer Protocol) is used as a protocol for a client to acquire contents from a server will be described. However, another protocol may be used.

In addition, in the ensuing embodiments, the case where a contents server, a relay apparatus, and a management server which are physically different have respective functions will be described. However, the same one apparatus may have the respective functions.

### First Embodiment

FIG. 3 is a diagram showing a physical configuration of a computer which implements a client 100, a relay apparatus 200, and a management server 400 in the present embodiment described later. The computer in the present embodiment includes a processor H201 which executes programs and implements processing functions described below, a memory apparatus H202 which temporarily retains programs to be executed and data, an input-output apparatus H203 for inputting a command or information from external, a disk apparatus H204 which stores entities of programs, commands, information and the like and which is used as data storage means, a communication control apparatus H205 which controls exchange of data with an external apparatus, an internal communication line H206 such as a bus for exchanging data within the computer, and an external communication line H207 for exchanging data between the inside of the computer and an external apparatus.

The programs may be previously stored in the memory apparatus H202 or the disk apparatus H204 in the computer, or may be introduced from a storage medium which can be utilized by the computer and attached to and detached from the computer or from another apparatus via a communication medium (a network or a carrier wave or a digital signal which propagate through a network) as occasion demands.

Furthermore, processing contents of each of the processing functions described below is implemented by the processor H201 which reads out a program stored in the disk apparatus H204 and executes the program.

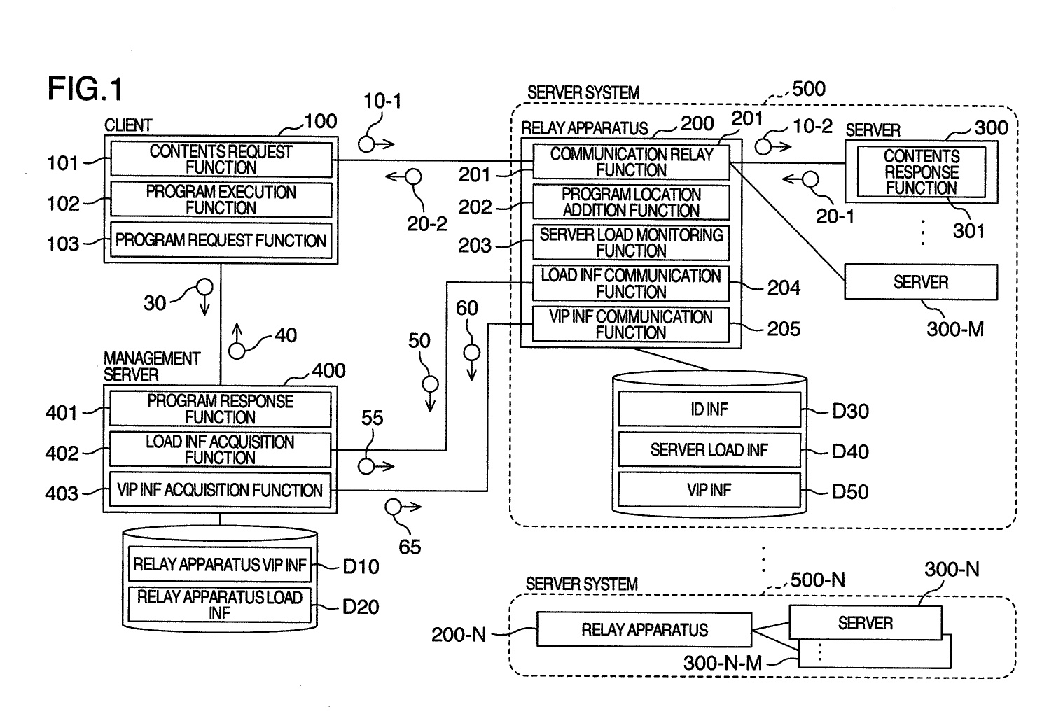

As shown in FIG. 1, the communication system according to the present embodiment is formed to include a server system 500 formed to include a relay apparatus 200 and one or more contents servers (referred to simply as servers) 300 to 300-M providing contents which are coupled via a network, a client 100 which acquires contents from the server system 500, and a management server 400. There are a plurality of server systems 500 (500 to 500-N), and all server systems are coupled to the client 100 and the management server 400 in the same way as the server system 500. There may be a plurality of clients 100. A general communication relay apparatus such as a router may exist among the client 100, the management server 400, and the server systems 500.

The client 100 operates as a Web browser having, for example, a contents request function 101, a program execution function 102, and a program request function 103.

The contents request function 101 transmits a contents request 10-1, and receives response contents 20-2. As for a communication protocol for acquiring contents, for example, the HTTP is conceivable. As for the contents, for example, an HTML file is conceivable.

The program execution function 102 executes a correction program acquired by the program request function which will be described later, and rewrites link information to other contents contained in response contents which are acquired from the server 300.

The program request function 103 acquires a program location added to the response contents 20-2 by a program location addition function 202 in the relay apparatus 200, from the response contents acquired by the contents request function 101. The program request function 103 transmits a program request 30 toward a destination (for example, the management server 400), and receives a program response 40 returned as a response.

The relay apparatus 200 includes a communication relay function 201, the program location addition function 202, a server load monitoring function 203, a load information (INF) communication function 204, a VIP information communication function 205, identifier (ID) information D30, server load information D40, and VIP information D50.

The communication relay function 201 receives the contents request 10-1 from the client 100 by using a virtual IP address the relay apparatus 200 has, and determines a server to which the contents request 10-1 is to be transferred, on the basis of the virtual IP address used for the reception. After determining the server of the transfer destination, the communication relay function 201 transmits a contents request 10-2 directed to the server (hereafter in the present embodiment the server 300 is supposed to be a transfer destination server).

A pair of a virtual IP address and a server of transfer destination is previously set as the VIP (Virtual IP address) information D50. A technique for receiving a request by using a virtual IP address and determining a transfer destination server is known.

The communication relay function 201 receives response contents 20-1 from the server 300, and transmits the response contents 20-2 generated on the basis of the response contents 20-1 by the program location addition function 202 in the relay apparatus 200 to the client 100 of the contents request source.

The program location addition function 202 adds a program location containing a source (for example, a URL of the management server 400) of a correction program for rewriting link information contained in the response contents 20-1 received from the server 300 by the communication relay function 201, to the response contents 20-1 and generates the response contents 20-2. The program location contains a relay apparatus identifier and a server identifier which make it possible to identify the relay apparatus 200 and the server 300, as parameters. By the way, the source of the correction program is previously set and stored.

The server load monitoring function 203 periodically acquires load information of the servers 300 to 300-M coupled to the relay apparatus 200, and stores the load information in the server load information D40. The server load information D40 contains, for example, an average response time of contents in a response of the server and an established TCP connection count of the server, in addition to the identifier of the server. A technique for acquiring the average response time and the established TCP connection count of the server is known.

The load information communication function 204 periodically transmits information of the server load information D40 stored by the load information communication function 204 to the management server 400 via the network as a load information response 50. In the transmission of the load information response 50, the load information response 50 is described by using, for example, the XML (Extensible. Markup Language) and its communication is conducted by using a protocol such as the HTTP.

The communication for transmitting the load information response 50 may be started by the relay apparatus 200, or may be started by the management server 400.

The VIP information communication function 205 transmits information of the VIP information D50 stored in the relay apparatus 200 to the management server 400 via the network as a VIP information response 3. In the transmission of the VIP information response 60, the IP address and the port number are described by using, for example, the XML, and the communication is conducted by using a protocol such as the HTTP. The transmission of the VIP information response 60 may be executed when an external operation has generated a change in the VIP information, or may be executed periodically. The communication for transmitting the VIP information response 60 may be started by the relay apparatus 200, or may be started by the management server 400.

The server 300 operates as, for example, a Web server having a contents response function 301.

The contents response function 301 receives the contents request 10-2, and returns the corresponding contents 20-1 as a response.

The server 300 is a general Web server, and all functions which constitute the server 300 are known techniques.

The management server 400 includes a program response function 401, a load information acquisition function 402, and a VIP information acquisition function 403.

Upon receiving the program request 30 from the client 100, the program response function 401 generates a correction program for rewriting link information of contents on the basis of a relay apparatus identifier A3 and a server identifier A4 contained in the program request 30 as the parameters and relay apparatus VIP information D10 and relay apparatus load information D20 stored in the management server 400, and transmits the correction program as the program response 40.

The load information acquisition function 402 receives the load information response 50 from the load information communication function 204 in the relay apparatus 200, calculates a load index of each server on the basis of the load information response 50, stores the load index in the relay apparatus load information D20, and updates it. For example, if the load information response 50 contains the average response time and the established TCP connection count of the server, the load index is calculated according to the following equation by using predetermined constants alpha and beta.

Load index=(average response time*alpha)+(session count*beta) Equation 1

“*” is a multiplication operator.

The VIP information acquisition function 403 receives the VIP information response 60 from the VIP information communication function 205 in the relay apparatus 200, and stores it in the relay apparatus VIP information D10.

Furthermore, the VIP information acquisition function 403 converts an IP address contained in the VIP information response 60 to a host name, and stores the host name as well in the relay apparatus VIP information D10. A technique for converting an IP address to a host name is known, and for example, a host name is acquired by inquiring of a DNS (Domain Name System) server.

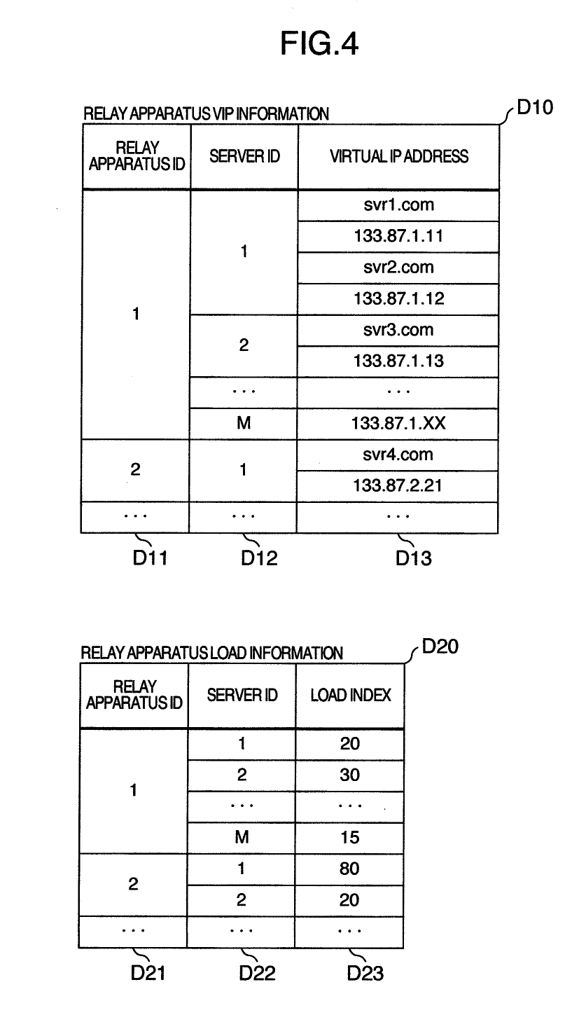

FIG. 4 shows an example of the relay apparatus VIP information D10 and the relay apparatus load information D20 stored in the management server 400.

The relay apparatus VIP information D10 stores information of the VIP information response 60 acquired from the VIP information communication function 205 in the relay apparatus 200 by the VIP information acquisition function 403 in the management server 400, as a relay apparatus identifier D11, a server identifier D12, and a virtual IP address D13. The virtual IP address D13 also stores the host name converted from the virtual IP address by the VIP information acquisition function 403, in addition to D51 in the relay apparatus 200.

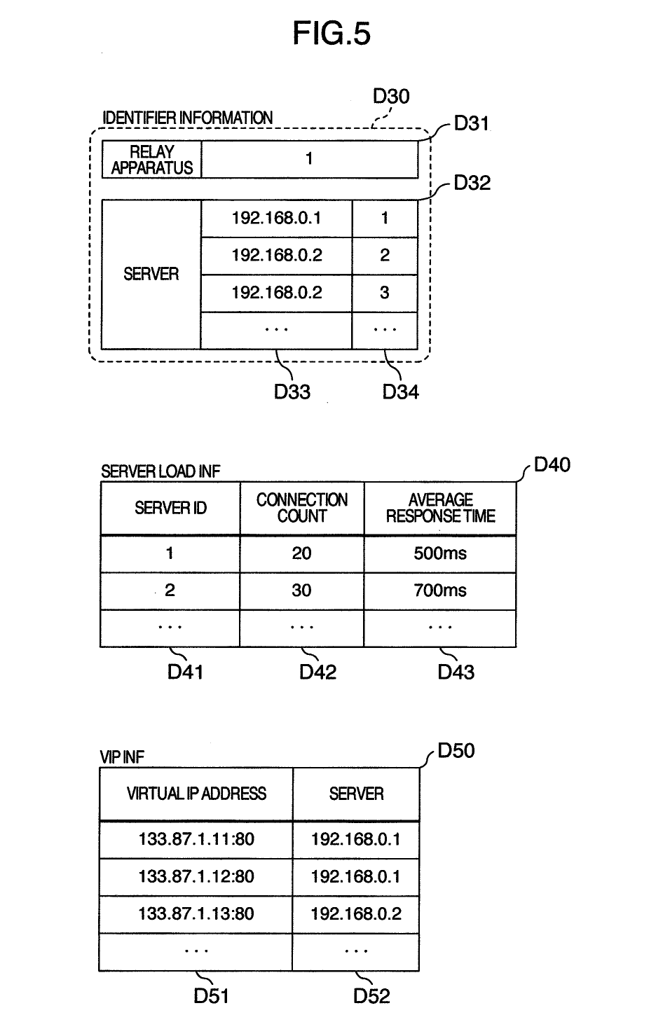

FIG. 5 shows an example of the identifier information D30, the server load information D40, and the VIP information D50 stored in the relay apparatus 200.

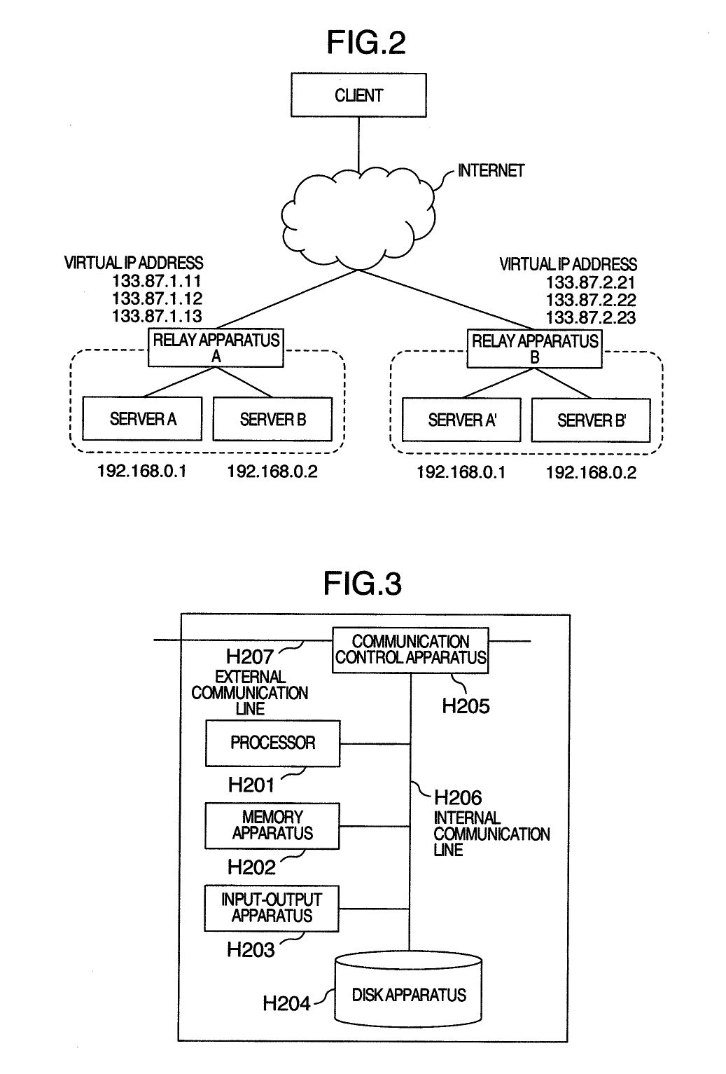

The identifier information D30 stores an identifier D31 which uniquely identifies the relay apparatus 400, and information D32 for uniquely identifying the servers 300 to 300-M coupled to the relay apparatus. As for the relay apparatus identifier D31, for example, a unique value may be set manually, or MAC (Media Access Control) address information which is unique every apparatus may be used. As for the information D32 for uniquely identifying the server, for example, a unique server identifier D34 is assigned to an IP address D33 of a server. By the way, for servers which balance requests from the client, such as the server A and the server A′ in FIG. 2, the same server identifier D34 is set.

The server load information D40 stores load information of every server acquired by the server load monitoring function 203. For example, the server load information D40 includes an established TCP connection count D42 and an average response time D43 in addition to a server identifier D41. As for the server identifier D41, a value of the server identifier D34 which is set in the identifier information D30 is used.

The VIP information D50 is information for determining a server to which a request received by the communication relay function 201 in the relay apparatus 200 with a virtual IP address is to be transferred. A virtual IP address D51 with which the relay apparatus receives a request and an IP address D52 of a server to which the request is to be transferred are stored.

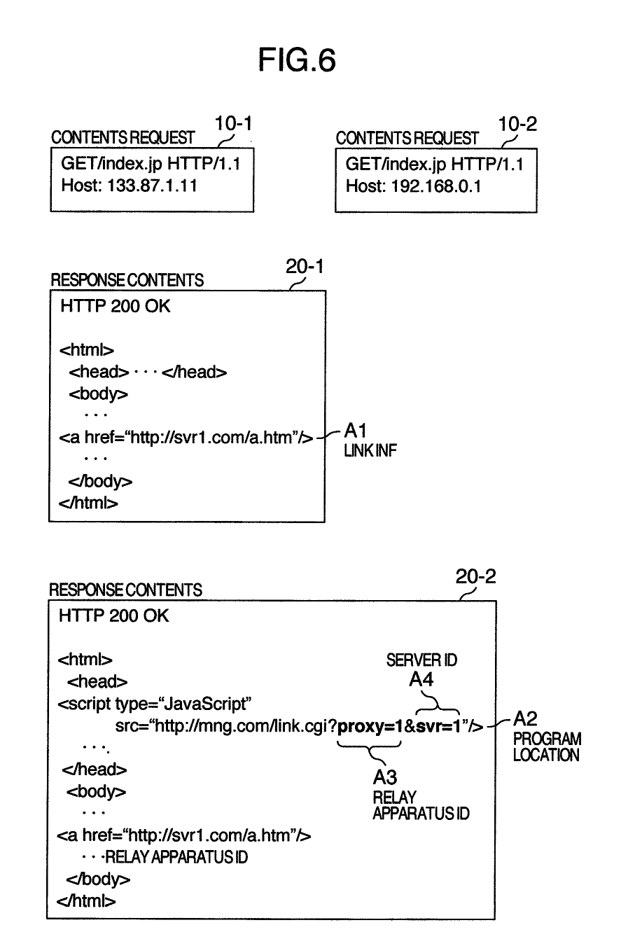

FIG. 6 shows an example of a contents request and response contents communicated among the client 100, the relay apparatus 200, and the server 300.

The contents request 10-1 is a request transmitted by the contents request function 101 in the client 100 to request acquisition of contents. For example, the contents request 10-1 is a HTTP request in HTTP communication.

The contents request 10-2 is a request which is generated on the basis of the contents request 10-1 received from the client 100 by the communication relay function 201 in the relay apparatus 200 and which is transmitted to the server 300. If a host name of a virtual IP address is contained in the contents request 10-1 as in a host header field of HTTP, the communication relay function 201 changes the host name to a server name of the server 300. By the way, the present technique is known.

The response contents 20-1 is a response transmitted to the relay apparatus by the content response function 301 in the server 300 upon receiving the contents request 10-2. The response contents 20-1 has link information A1 which indicates a location of other contents. For example, in the HTML contents, the link information is described in the anchor tag by using the URL (Uniform Resource Locater).

The response contents 20-2 are obtained by addition of a program location A2 to the response contents 20-1 received from the server 300, which is conducted by the program location addition function 202 in the relay apparatus 200. And the response contents 20-2 are a response transmitted to the client 100 of contents request source by the communication relay function 201. The program location A2 includes the relay apparatus identifier A3 which identifies the relay apparatus 200, and the server identifier A4 which identifies the server 300 of response contents source. For example, in HTML contents, the program location A2 is described as an SRC attribute value of a script tag, and the relay apparatus identifier A3 and the server identifier A4 are described as a CGI parameter of the attribute value.

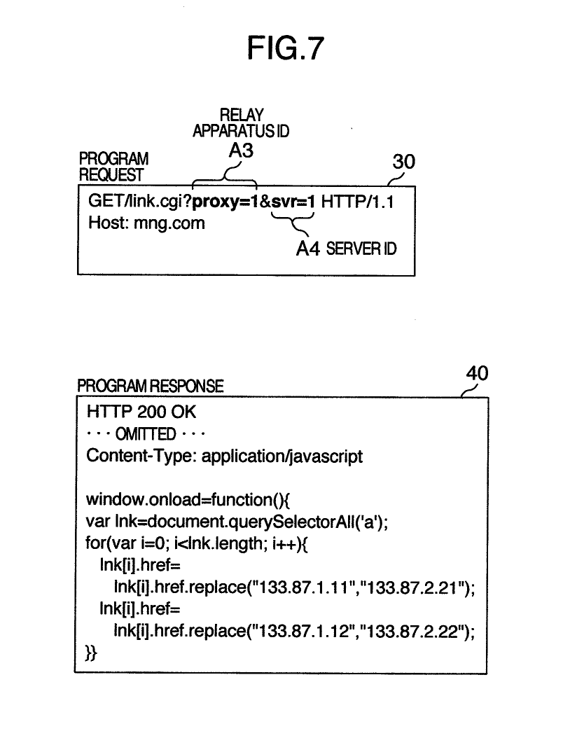

FIG. 7 shows an example of a program request and a program response communicated between the client 100 and the management server 400.

The program request 30 is a request transmitted to a destination (for example, the management server 400) indicated by the program location A2 which is contained in the response contents 20-2 acquired by the contents request function 101 in the client 100, by the program request function 103 in the client 100. By the way, the program request 30 has information of the relay apparatus identifier A3 and the server identifier A4 contained in the program location A2 in the response contents 20-2 as the parameters. For example, if the program request 30 is an HTTP request, the program request 30 has the relay apparatus identifier A3 and the server identifier A4 as CGI parameters of a request URL.

The program response 40 is a response generated on the basis of the relay apparatus identifier A3 and the server identifier A4 contained in the program response 30 as parameters and the relay apparatus VIP information D10 and the relay apparatus load information D20 stored in the management server 400 and transmitted to the client by the program response function 401 in the management server 400 upon receiving the program request 30 from the client 100. The program response 40 contains a correction program which converts a character string of link information contained in the contents to a different character string. By the way, the program response 40 in FIG. 7 shows an example in which the correction program is described by using JavaScript (registered trademark).

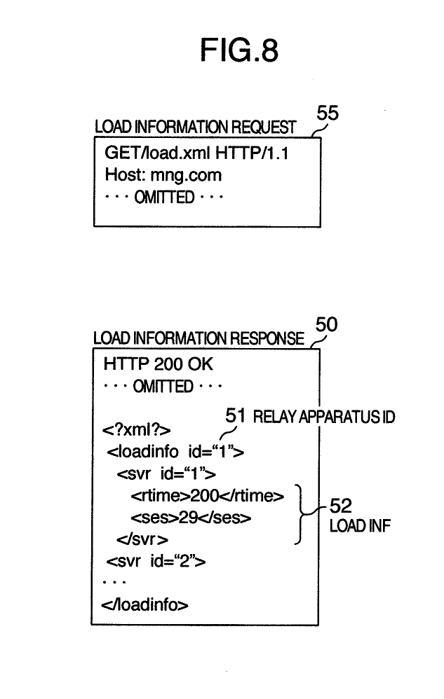

FIG. 8 shows an example of a load information request and a load information response communicated between the relay apparatus 200 and the management server 400. In the present embodiment, an example of pull-type communication in which a request is transmitted from the management server 400 is shown. However, push-type communication in which information is transmitted from the relay apparatus 200 as a notice may be used.

A load information request 55 is transmitted to the load information communication function 204 in the relay apparatus 200 to request the server load information D40 by the load information acquisition function 402 in the management server 400.

The load information response 50 is a response transmitted to the load information request 55 by the load information communication function 204 in the relay apparatus 200. The load information response 50 contains a relay apparatus identifier 51, and contains information of the server load information D40 in each server connected to the relay apparatus as load information 52.

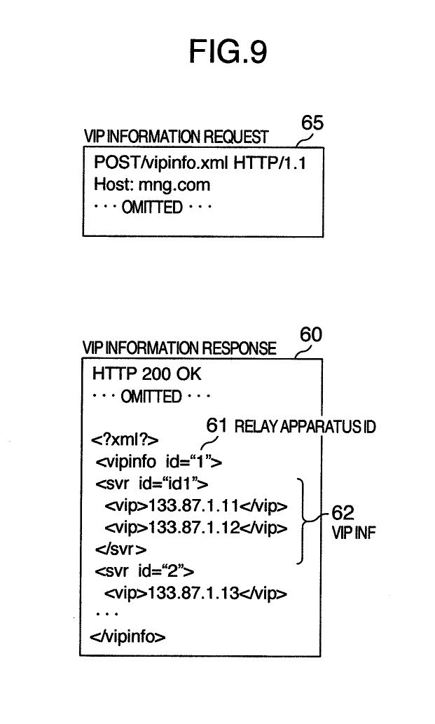

FIG. 9 shows an example of a VIP information request and a VIP information response communicated between the relay apparatus 200 and the management server 400. In the present embodiment, an example of pull-type communication in which a request is transmitted from the management server 400 is shown. However, push-type communication in which information is transmitted from the relay apparatus 200 as a notice may be used.

A VIP information request 65 is transmitted to the VIP information communication function 205 to request the VIP information D50 by the VIP information acquisition function 403 in the management server 400

The VIP information response 60 is a response transmitted in response to the VIP information request 65 by the VIP information communication function 205 in the relay apparatus 200. The VIP information response 60 includes a relay apparatus identifier 61, and VIP information 62 which is formed to include the virtual IP address D51 corresponding to the server identifier D34 of each server coupled to the relay apparatus.

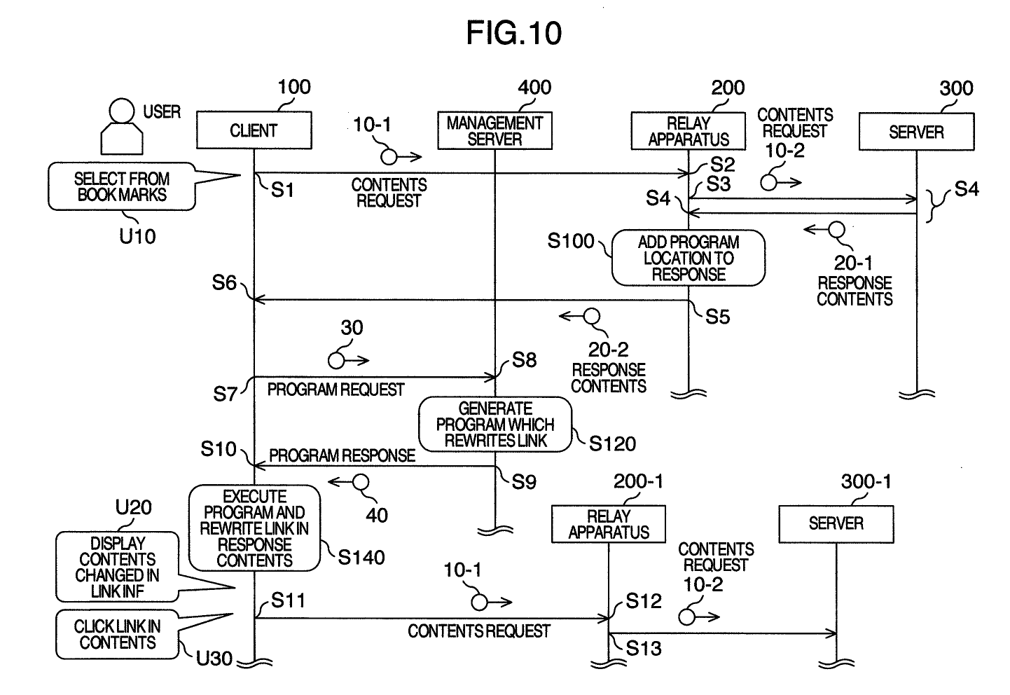

FIG. 10 shows an example of a communication sequence at the time when a client acquiring contents from the server 300 acquires contents from the server 300-1 by rewriting link information. In the present sequence, an example using a Web browser as the client 100, a Web server as the server 300, an HTML file as contents to be acquired, and HTTP as the communication protocol is mentioned. However, they are not restrictive.

First, a user clicks a link to contents of the server 300 displayed by the client 100 (Web browser) or contents of the server 300 registered in a book mark with a mouse (U10). Thereupon, the client 100 transmits the contents request 10-1 directed to a virtual IP address the relay apparatus 200 has (S1).

If the communication relay function 201 in the relay apparatus 200 receives the contents request 10-1 (S2), then the communication relay function 201 rewrites a host header field and the like to a suitable value, and transmits the contents request 10-2 directed to the server 300 (S3).

Upon receiving the contents request 10-2, the contents response function 301 in the server 300 transmits the response contents 20-1 depending upon contents of the request to the relay apparatus 200 (S4).

If the communication relay function 201 in the relay apparatus 200 receives the response contents 20-1 (S4), then the program location addition function 202 adds the program location A2 to the response contents 20-1 (S100). The communication relay function 201 transmits the response contents 20-2 having the program location A2 added thereto to the client 100 of contents request source (S5).

Upon acquiring the response contents 20-2 (S6), the contents request function 101 in the client 100 analyzes the response contents 20-2 in order to display the contents. Upon detecting the program location A2 in the analysis of the response contents 20-2, the client 100 transmits the program request 30 to a URL indicated by the program location A2 (S7).

Upon receiving the program request 30 (S8), the program response function 401 in the management server 400 generates a program (S120) and transmits the program to the client as the program response 40 (S9).

If the program request function 103 in the client receives the program response 40 (S10), then the program execution function 102 rewrites link information contained in the response contents 20-2 in accordance with a correction program contained in the program response 40 (S140), and displays the contents having the rewritten link information to the user (U20).

If the user clicks a rewritten link contained in the page with the object of further acquiring contents (U30), then the client transmits the contents request 10-1 to a destination of the rewritten link (for example, a virtual IP address of the relay apparatus 200-1) (S11). The relay apparatus 200-1 receives the request (S12), and transmits the contents request 10-2 to the server 300-1 in accordance with the received virtual IP address.

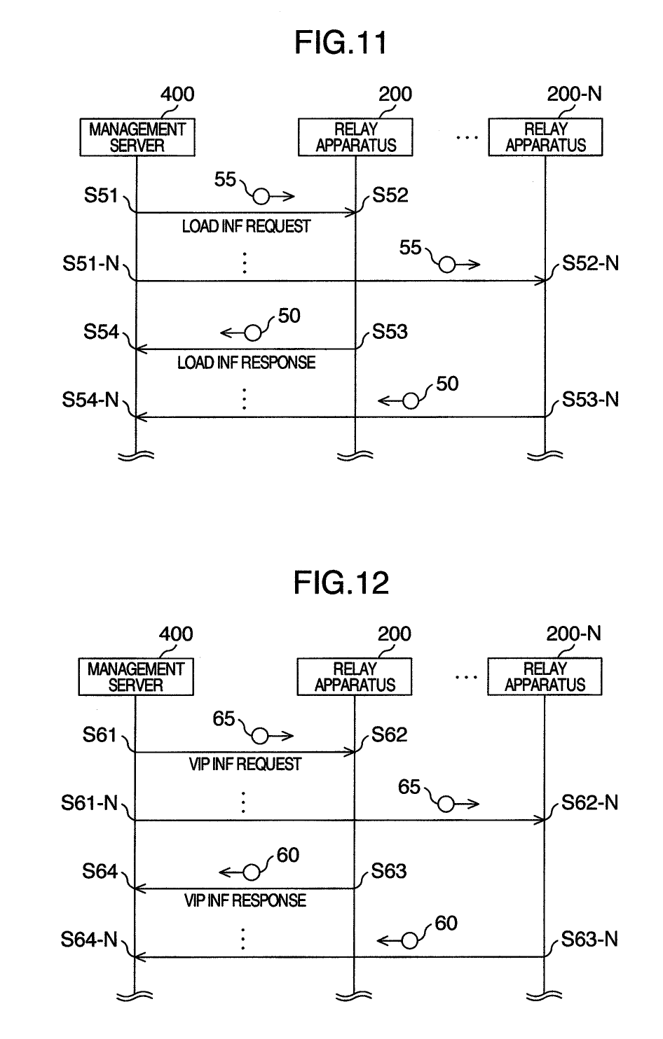

FIG. 11 shows an example of a communication sequence at the time when the management server 400 acquires information from the relay apparatuses 200 to 200-N, and generates and updates the relay apparatus load information D20. The present communication sequence is executed repetitively at predetermined constant intervals.

The load information acquisition function 402 in the management server 400 transmits the load information request 55 to the relay apparatuses 200 to 200-N coupled via a network or the like (S51 to S51-N). Upon receiving the load information request 55 (S52 to S52-N), the load information communication function 204 in the relay apparatuses 200 to 200-N generates the load information response 50 on the basis of the server load information D40, and transmits the load information response 50 directed to the management server 400 (S53 to S53-N).

Upon receiving the load information response 50 from the relay apparatuses 200 to 200-N (S54 to S54-N), the load information acquisition function 402 in the management server 400 conducts addition and update on the relay apparatus load information D20 on the basis of the information.

FIG. 12 shows an example of a communication sequence at the time when the management server 400 conducts communication with the relay apparatuses 200 to 200-N and conducts addition and update on the relay apparatus VIP information D10.

The VIP information acquisition function 403 in the management server 400 transmits the VIP information request 65 to the relay apparatuses 200 to 200-N coupled via a network or the like (S61 to S61-N). Upon receiving the VIP information request 65 (S62 to S62-N), the VIP information communication function 205 in the relay apparatuses 200 to 200-N generates the VIP information response 60 on the basis of the VIP information D50 included in each relay apparatus, and transmits the VIP information response 60 directed to the management server 400 (S63 to S63-N).

Upon receiving the VIP information response 60 from the relay apparatuses 200 to 200-N (S64 to S64-N), the VIP information acquisition function 403 in the management server 400 conducts addition and update on the relay apparatus VIP information D10 on the basis of the information.

If the relay apparatus VIP information D10 is an IP address, then the VIP information acquisition function 403 in the management server 400 acquires a host name corresponding to the IP address (for example, by inquiring of the DNS server), and adds the host name to the relay apparatus VIP information D10 to update the relay apparatus VIP information D10.

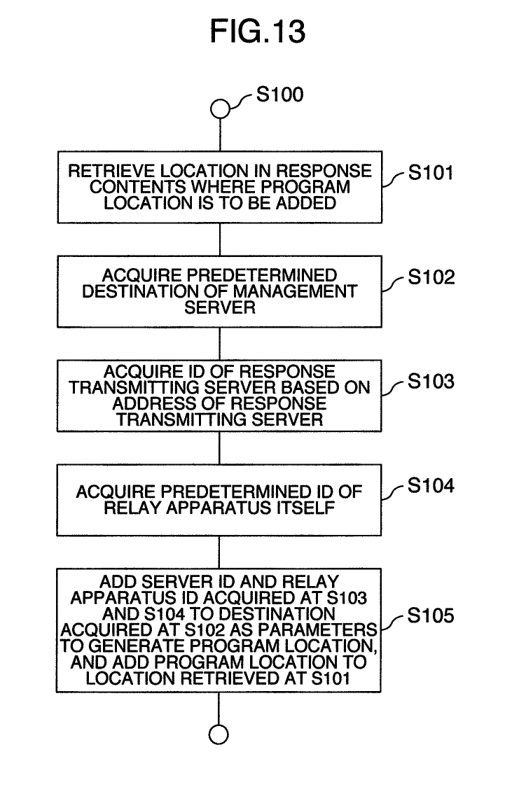

FIG. 13 shows an example of a processing flow in which the program location addition function 202 in the relay apparatus 200 adds a program location to response contents 20-1 from the server 300. The present flow is equivalent to the processing at S100 in FIG. 10.

The program location addition function 202 first detects a location in the response contents 20-1 where a program location is to be added (S101). If the contents are HTML, the location where the program location is to be added is, for example, head of a HEAD element.

Then, the program location addition function 202 acquires a preset destination for acquiring a correction program (S102). If the communication protocol is the HTTP, the destination is described by using, for example, a URL.

Then, the program location addition function 202 acquires a server identifier by referring to the identifier information D32 on the basis of an address of a response transmitting server (S103).

In the same way, the program location addition function 202 acquires a relay apparatus identifier of the relay apparatus itself on the basis of the identifier information D31 (S104).

The program location addition function 202 adds the server identifier and the relay apparatus identifier respectively acquired at S103 and S104 to the destination acquired at S102, as parameters (if the contents are HTML, for example, as CGI parameters), generates a program location in a form suitable for the response contents (if the contents are HTML, for example, in a form of SCRIPT element), and adds the program location to the location detected at S101 (S105).

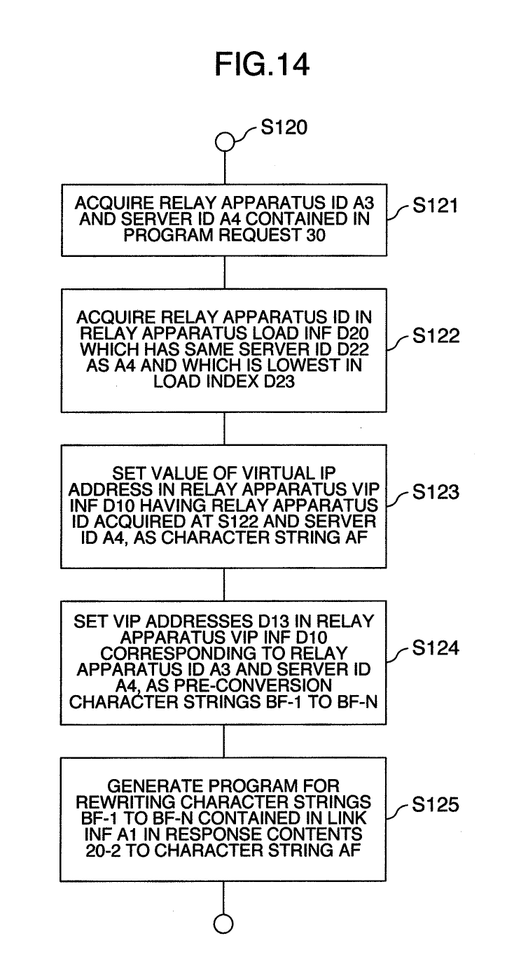

FIG. 14 shows an example of a processing flow in which the program response function 401 in the management server 400 generates a program response. The present flow is equivalent to the processing at S120 in FIG. 10.

The program response function 401 first acquires the relay apparatus identifier A3 and the server identifier A4 contained in the program request 30 (S121).

Then, the program response function 401 acquires a relay apparatus identifier D21 in the relay apparatus load information D20 which has the same server identifier D22 as the acquired server identifier A4 and which is the lowest in value of the load index D23, as a destination relay apparatus identifier (S122).

After acquiring the destination relay apparatus identifier, the program response function 401 acquires a virtual IP address D13 in the relay apparatus VIP information D10 which has a relay apparatus identifier D11 equal to the destination relay apparatus identifier and a server identifier D12 equal to the server identifier A4, and sets a value of the virtual IP address D13 as a character string AF (S123). Furthermore, if there are a plurality of pertinent virtual IP addresses D13, the program response function 401 selects one out of them (for example, a value which appears first).

Then, the program response function 401 acquires a virtual IP address D13 in the relay apparatus VIP information D10 which has a relay apparatus identifier D11 and a server identifier D12 respectively equal to the relay apparatus identifier A3 and the server identifier A4 acquired at S121, and sets a value of the virtual IP address D13 as a character string BF. If there are a plurality of pertinent virtual IP addresses D13, the program response function 401 sets values of them as character strings BF to BF-N (S124).

Finally, the program response function 401 generates a correction program to replace the character strings BF-1 to BF-N in a link contained in the response contents 20-2 acquired by the client with the character string AF (S125). Generation of the correction program for replacing the character strings can be implemented by using a known technique.

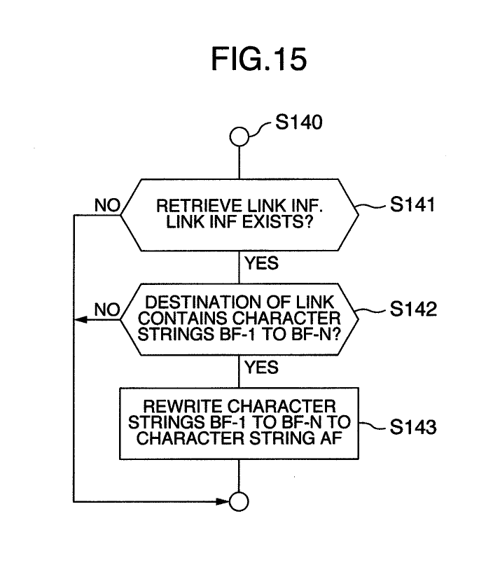

FIG. 15 shows an example of a processing flow in which the program execution function 102 in the client 100 executes the program response 40 acquired from the management server 400 and rewrites contents of a link contained in the response contents 20-2. The present flow is equivalent to the processing at S140 in FIG. 10. By the way, the present processing depends upon contents of the program response 40 given by the program response function 401 in the management server 400.

The program execution function 102 in the client 100 detects all link information contained in the response contents 20-2 in accordance with the contents of the program response 40 (S141). In HTML, the link information is, for example, an A element (anchor element).

Then, if the link information is detected (YES at S141), then the program execution function 102 makes a decision whether the character strings BF-1 to BF-N in the sequence S120 are contained in a contents location contained in the detected link information (S142). In HTML, the contents location is, for example, an HREF attribute value of the A element.

If the link information contains the character strings BF-1 to BF-N (YES at S142), then the program execution function 102 replaces the character strings BF-1 to BF-N with the character string AF in the sequence S120 (S143).

Even if a relay apparatus is provided in a stage preceding servers, it is possible according to the present embodiment described heretofore to rewrite a link of contents acquired by the client to set a server having a lighter load as the destination and implement wide area load balancing according to the load situation of the servers, without adding an individual function to the servers.

### Second Embodiment

The second embodiment is an embodiment in which, when the load of the relay apparatus itself is heavy, link information of contents is rewritten to set a server having another relay apparatus as a way point to a destination, regardless of the load of the server in a stage subsequent to the heavy load relay apparatus.

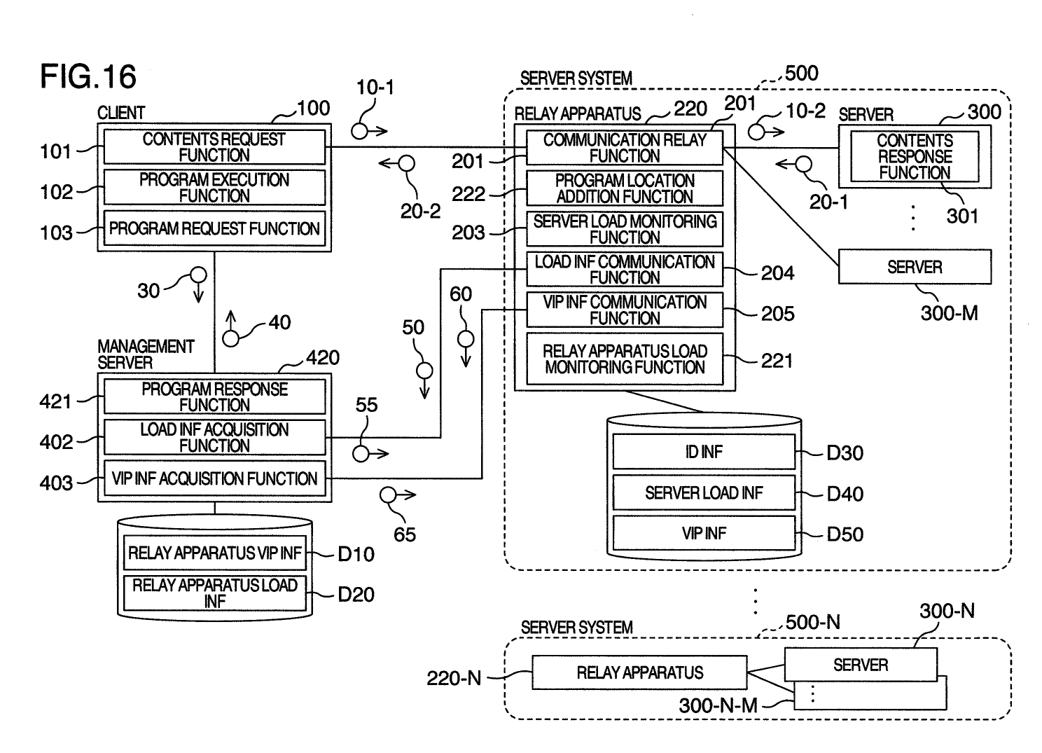

FIG. 16 shows a configuration example of a system according to the second embodiment.

A relay apparatus 220 in the second embodiment has a relay apparatus load monitoring function 221 in addition to the relay apparatus 200 in the first embodiment. Furthermore, a program location addition function 222 differs from the program location addition function 202 in the first embodiment. A program response function 421 included in a management server 420 differs from the program response function 401 included in the management server 400 in the first embodiment. Other configurations are the same as those in the first embodiment.

The relay apparatus load monitoring function 221 periodically calculates a load index of the relay apparatus 220 on the basis of a CPU (Central Processing Unit) usage factor of the relay apparatus 220 and the established TCP connection count of the relay apparatus 220. For example, the load index is calculated according to the following equation by using predetermined constants alpha and beta.

Load index=(CPU usage factor*alpha)+(session count*beta) Equation 2

If the load index calculated by the relay apparatus load monitoring function 221 exceeds a predetermined value, then the program location addition function 222 causes parameters of the program location A2 used when adding the program location to the response contents (S100 in FIG. 10) to contain the relay apparatus identifier A3, but not to contain the server identifier A4.

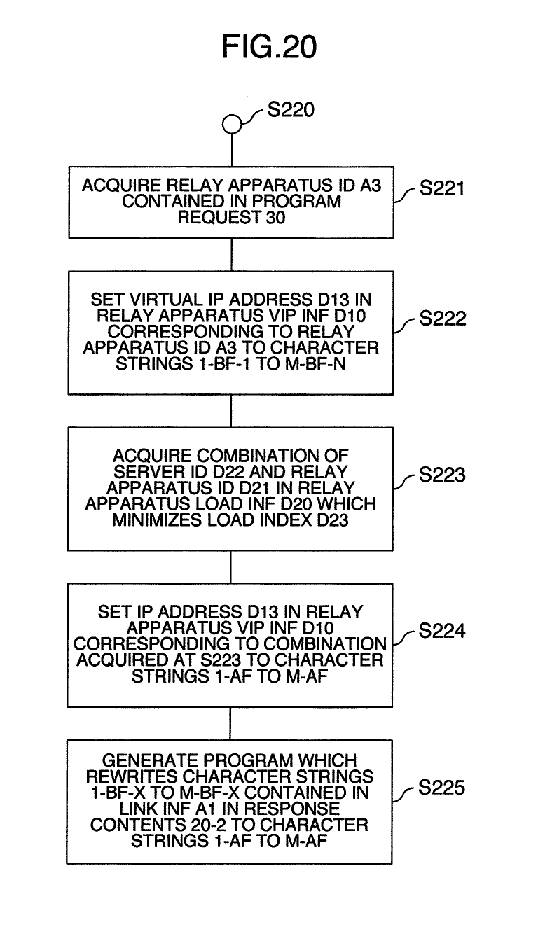

An example of a processing flow in the case where the program response function 421 in the management server 420 has received the program request 30 which does not contain the server identifier A4 is shown in S220 in FIG. 20.

Upon receiving the program request 30 which does not contain the server identifier A4, the program response function 421 in the management server 420 acquires the relay apparatus identifier A3, but does not acquire the server identifier A4 (S221).

Then, the program response function 421 acquires a virtual IP address D13 in the relay apparatus VIP information D10 corresponding to a relay apparatus identifier D11 equal to the acquired relay apparatus identifier A3, and sets the virtual IP address D13 as character strings 1-BF-1 to M-BF-N every server identifier D12 (1 to M) (S222).

Furthermore, the program response function 421 acquires a combination of a server identifier D22 and a relay apparatus identifier D21 in the relay apparatus load information D20 which minimizes a value of the load index D23, every server identifier D22 having a relay apparatus identifier D21 equal to the acquired relay apparatus identifier A3. If the relay apparatus identifier D21 in the combination is equal to the acquired relay apparatus identifier A3, then the program response function 421 acquires a combination which gives a second minimum value of the load index D23 (S223).

The program response function 421 selects one virtual IP address D13 in the relay apparatus VIP information D10 which corresponds to the combination of the server identifier D22 and the relay apparatus identifier D21 acquired at S223, and sets a value of the virtual IP address D13 as character strings 1-AF to M-AF every server identifier D13 (1 to M) (S224).

Finally, the program response function 421 generates a correction program which replaces character strings 1-BF-X to M-BF-X (where X is an arbitrary character) in a link contained in the response contents 20-2 acquired by the client with character strings 1-AF to M-AF (S225). Generation of the correction program which replaces character strings can be implemented by using a known technique.

By the way, if the program response function 421 receives the program request 30 which includes both the server identifier A4 and the relay apparatus identifier A3, a processing flow equivalent to the processing flow at S120 in FIG. 10 is conducted.

Even if the load of the relay apparatus itself has become heavy, it is possible according to the present embodiment described heretofore to rewrite a link of contents to cause a request from the client to be directed to a server via another relay apparatus and it is possible to prevent the relay apparatus from becoming a bottleneck in processing.

### Third Embodiment

The third embodiment is an embodiment in which load balancing to other servers is executed when the load of the relay apparatus or a server apparatus is heavy, and the relay apparatus is prevented from adding a program location to response contents at the normal time to reduce processing in the relay apparatus, client, and management server.

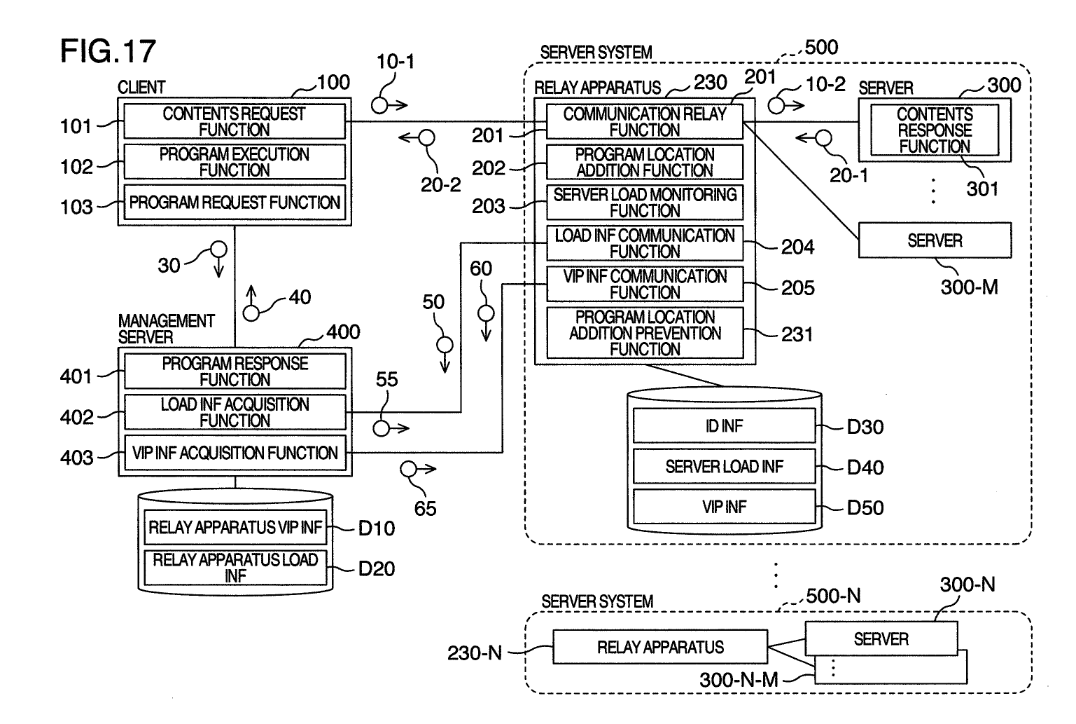

FIG. 17 shows a configuration example of a system according to the third embodiment.

A relay apparatus 230 shown in FIG. 17 has a program location addition prevention function 231 in addition to the relay apparatus 200 in the first embodiment. Other configurations are the same as those in the first embodiment.

If the communication relay function 201 receives the response contents 20-1 from a server, then the program location addition prevention function 231 in the relay apparatus 230 calculates a load index L1 of the server on the basis of the server load information D40. As for a calculation method of the load index L1, for example, Equation 1 in the first embodiment is used.

If the calculated load index L1 is equal to or less than a predetermined value Y, then the program location addition prevention function 231 prevents the program location addition function 202 from adding a program location to the response contents 20-1 from the server. As a result, link information of the contents 20-2 acquired by the client is not rewritten.

If the load index L1 exceeds Y, then the program location addition prevention function 231 does not prevent addition of the program location and the relay apparatus 230 conducts processing in the same way as the relay apparatus 200 in the first embodiment.

Furthermore, the program location addition prevention function 231 has a function of periodically measuring a load index of the relay apparatus 230 as a load index L2 in the same way as the relay apparatus load monitoring function 221 in the second embodiment, and may have a function of comparing a greater value of the load index L1 and the load index L2 with a constant gamma. As a result, a program location can also be added in the case where loads of the servers 300 to 300-N are light, but a load of the relay apparatus 230 is heavy.

According to the present embodiment described heretofore, link rewriting of contents is not executed when the load of the relay apparatus or the server is not heavy. As a result, unnecessary processing and communication can be suppressed.

### Fourth Embodiment

A fourth embodiment is an embodiment in which a plurality of management servers are installed and a processing quantity per management server is reduced by distributing the program request destinations to the plurality of management servers.

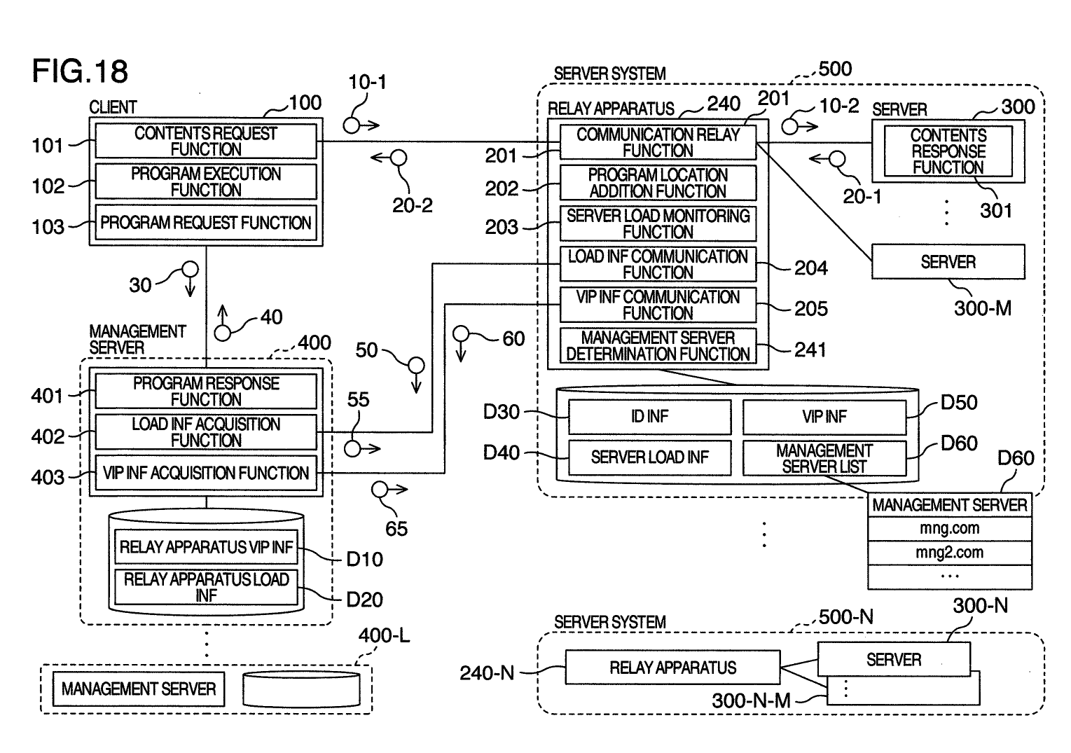

FIG. 18 shows a configuration example of a system according to the fourth embodiment.

A relay apparatus 240 shown in FIG. 18 has a management server determination function 241 and a management server list D60 in addition to the relay apparatus 200 in the first embodiment. Furthermore, in the configuration of the fourth embodiment, there are a plurality of management servers 400 (400 to 400-L), and all of them are connected to other management servers, the client, and the relay apparatus via a network.

The management server list D60 stores destinations (in HTTP, for example, URLs) of management servers (400 to 400-L) connected via the communication network. Information in the list may be set manually, or may be notified from a management server via the network.

The management server determination function 241 selects a source of a correction program contained in a program location which is added by the program location addition function 202 from the management server list D60, and the program location addition function 202 generates a program location to set the selected destination management server as the destination of the program request. A scheme for making selection from the list may be a round robin scheme in which selection is made in order beginning with the head of the list, or may be another load balancing scheme.

It is possible according to the present embodiment to conduct load balancing among a plurality of management servers and prevent the management server from becoming a bottleneck of the system.

Furthermore, the present embodiment can be combined with the second embodiment and/or the third embodiment.

### Fifth Embodiment

The fifth embodiment is an embodiment in which the relay apparatus itself generates a correction program for rewriting the link of contents without requiring a management server, adds the correction program to the contents, and responds to the client, and the client rewrites the link in accordance with the correction program.

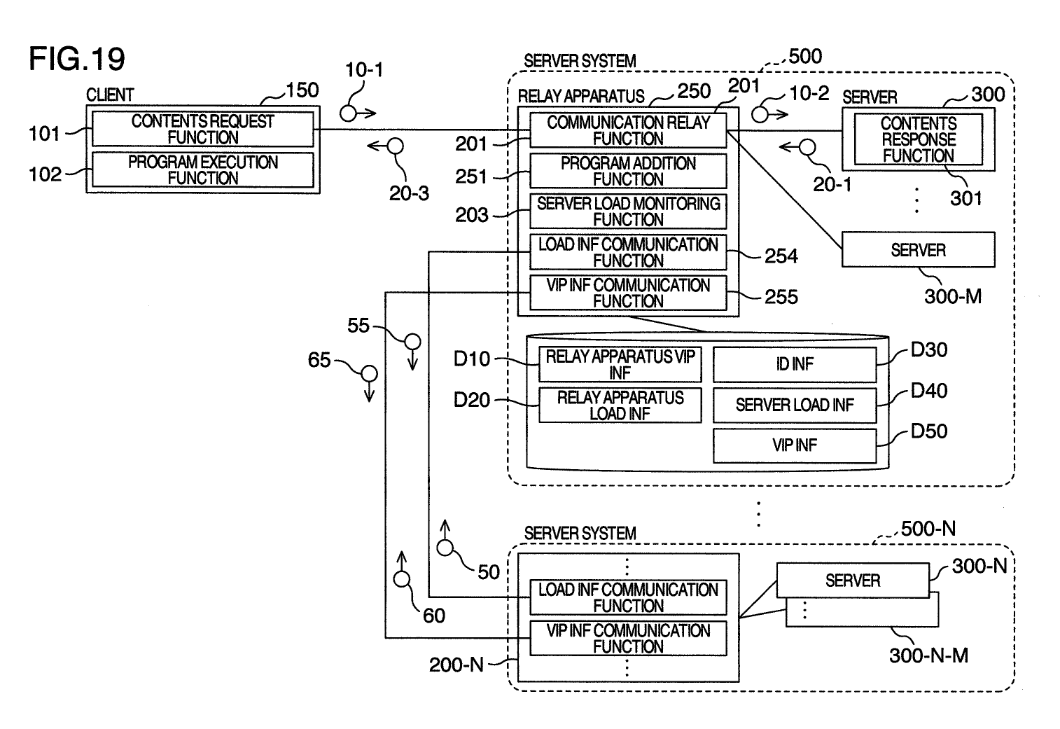

FIG. 19 shows a configuration example of a system according to the fifth embodiment.

A relay apparatus 250 shown in FIG. 19 has a program addition function 251, relay apparatus VIP information D10, and relay apparatus load information D20 in addition to the relay apparatus 200 in the first embodiment. Furthermore, a load information communication function 254 and a VIP information communication function 255 in the relay apparatus 250 are different from the load information communication function 204 and the VIP information communication function 205 in the relay apparatus 200 in the first embodiment. The relay apparatus 250 need not have the program location addition function 202 in the relay apparatus 200 in the first embodiment.

A client 150 need not have the program request function 103 in the first embodiment.

The system according to the fifth embodiment does not need the management server 400 in the first embodiment. Furthermore, relay apparatuses 250 to 250-N are connected via a communication network.

The load information communication function 254 and the VIP information communication function 255 in the relay apparatus 250 have functions similar to those of the load information acquisition function 402 and the VIP information acquisition function 403 in the management server in the first embodiment in addition to the functions of the load information communication function 204 and the VIP information communication function 205 in the relay apparatus 200 in the first embodiment.

The load information communication function 254 transmits the load information request 55 to a relay apparatus other than itself, receives the load information response 50 transmitted by the load information communication function 254 in each relay apparatus as a response, and stores the load information response 50 in the relay apparatus load information D20.

The VIP information communication function 255 transmits the VIP information request 65 to a relay apparatus other than itself; receives the VIP information response 60 transmitted by the VIP information communication function 255 in each relay apparatus as a response, and stores the VIP information response 60 in the relay apparatus VIP information D10.

The relay apparatus VIP information D10 and the relay apparatus load information D20 included in each relay apparatus are equivalent to the relay apparatus VIP information D10 and the relay apparatus load information D20 included in the management server 400 in the first embodiment.

In addition to a function of generating a correction program A50 which rewrites link information of contents on the basis of the server identifier of a response contents transmitting server, the relay apparatus identifier of itself, the relay apparatus VIP information D10, and the relay apparatus load information D20 in the same way as the function of the program response function 401 in the management server 400 in the first embodiment, the program addition function 251 has a function of adding the correction program A50 to the response contents 20-1 and generating response contents 20-3. The technique for a relay apparatus to add the correction program to the response contents transmitted from a server is known (for example, U.S. Patent Application No. 2009/0300103 A1).

If the contents request function 101 in the client 150 receives the response contents 20-3, then the program execution function 102 rewrites link information of the response contents 20-3 in accordance with the correction program A50 contained in the response contents.

Furthermore, instead of adding the generated correction program A50 to the contents, the program addition function 251 may rewrite link information of the response contents 20-1, generate response contents 20-4, and transmit the response contents 20-4 to the client as a response. At this time, the correction program A50 is not added.

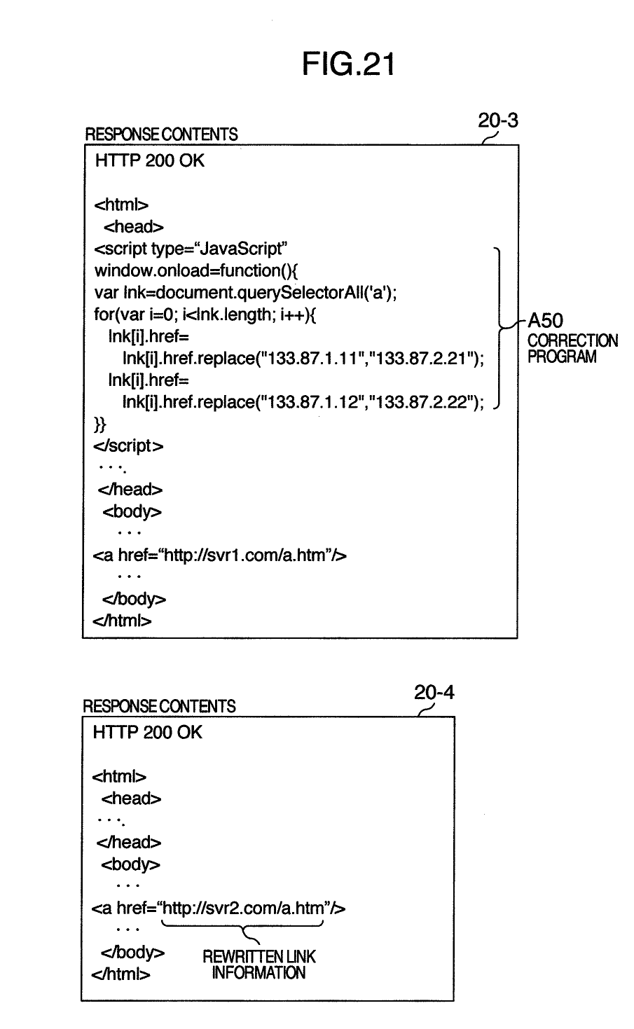

FIG. 21 shows the response contents 20-3 and 20-4.

According to the present embodiment described heretofore, the relay apparatus adds the correction program which rewrites the link of contents to the response contents. As a result, it is possible to rewrite the link of contents without needing the management server and requests of servers from clients can be balanced.

Furthermore, the present embodiment can be combined with the second embodiment and/or the third embodiment.

The specification and drawings are, accordingly, to be regarded in an illustrative rather than a restrictive sense. It will, however, be evident that various modifications and changes may be made thereto without departing from the spirit and scope of the invention(s) as set forth in the claims.

1. A communication system comprising a terminal, a contents server, a relay apparatus, and a management server connected via a network,
the relay apparatus comprising:
a communication relay unit for relaying a contents request transmitted from the terminal, to the contents server; and
a program location addition unit for adding a program location comprising a location and parameters of a source of a correction program which modifies information contained in response contents transmitted from the contents server in response to the contents request, to the response contents,
the terminal comprising:
a contents request unit for transmitting the contents request;
a program request unit for transmitting a program request containing parameters indicated by the program location to the source of the correction program indicated by the program location and acquiring the correction program; and
a program execution unit for executing the acquired correction program, and
the management server comprising a program response unit for receiving the program request, generating the correction program according to the parameters contained in the program request, and transmitting the correction program to the program request transmitting terminal as a response.

2. The communication system according to claim 1, wherein
the program response unit in the management server generates the correction program to be transmitted as the response to the program request on the basis of the parameters contained in the program request, communication load information of the server, and address information of the contents server.

3. The communication system according to claim 2, wherein
the relay apparatus comprises:
a server load monitoring unit for measuring the communication load of the contents server as the server load;
a load information communication unit for transmitting the server load information to the management server; and
a VIP information communication unit for transmitting the address of the contents server to the management server as VIP information, and
the management server comprises:
a load information acquisition unit for acquiring the server load information; and
a VIP information acquisition unit for acquiring the VIP information.

4. The communication system according to claim 1, wherein
the relay apparatus comprises a relay apparatus load monitoring unit for measuring a relay apparatus load index which indicates a degree of a communication load of the own relay apparatus,
if the relay apparatus load index measured by the relay apparatus load monitoring unit exceeds a predetermined value, then the program location addition unit changes contents of the program location to be added, on the basis of a result thereof, and
the program response unit in the management server generates contents of the correction program on the basis of the program location obtained by the change.

5. The communication system according to claim 1, wherein
the relay apparatus further comprises a program location addition prevention unit,
the server load monitoring unit in the relay apparatus measures a load of the contents server as a server load index, and
if the server load index does not exceed a predetermined value, then the program location addition prevention unit prevents the program location from being added to the response from the contents server.

6. The communication system according to claim 5, wherein
the program location addition prevention unit in the relay apparatus further measures a relay apparatus load index which indicates a degree of a communication load of the own relay apparatus,
if the relay apparatus load index or the server load index, whichever is greater in value, does not exceed the predetermined value, then the program location addition prevention unit prevents the program location from being added to the response contents.

7. The communication system according to claim 1, wherein
a plurality of the management servers are provided, and
the relay apparatus comprises:
a management server list for storing destinations respectively of the plurality of management servers; and
a management server determination unit for selecting a source of the correction program contained in the program location by the program location addition unit from within the management server list to conduct load balancing.

8. A communication system comprising a terminal, a contents server, and a relay apparatus connected via a network,
the relay apparatus comprising:
a communication relay unit for relaying a contents request transmitted from the terminal, to the contents server; and
a program addition unit for generating a correction program which modifies information contained in response contents transmitted from the contents server, in accordance with an identifier of the contents server, and adding the generated correction program to the response contents transmitted from the contents server,
the terminal comprising:
a contents request unit for transmitting the contents request; and
a program execution unit for executing the correction program contained in the response contents.

9. The communication system according to claim 8, wherein
a plurality of the relay apparatuses are provided,
in each of the relay apparatuses,
the load information communication unit acquires load information of the contents server measured by the server load monitoring unit in a different relay apparatus, by conducting communication with the different relay apparatus,
the VIP information communication unit acquires address information of the contents server connected to the different relay apparatus by conducting communication with the different relay apparatus, and
the program addition unit in the relay apparatus generates the correction program on the basis of the acquired load information and address information of the contents server and adds the correction program.

10. The communication system according to claim 8, wherein
the program addition unit does not add the generated correction program to the response contents, but executes the correction program with respect to the response contents and transmits a result thereof to the terminal as the response contents.
